(19) United States
(12) Patent Application Publication
(10) Pub. No.: US 2024/0046779 A1
(43) Pub. Date: Feb. 8, 2024

(54) DRIVING DETERMINATION SYSTEM, DRIVING DETERMINATION METHOD, AND RECORDING MEDIUM

(71) Applicant: NEC Corporation, Minato-ku, Tokyo (JP)

(72) Inventors: Chisato Sugawara, Tokyo (JP); Nana Jumonji, Tokyo (JP); Yosuke Kimura, Tokyo (JP); Masaya Tokunaga, Tokyo (JP); Toru Takami, Tokyo (JP)

(73) Assignee: NEC Corporation, Minato-ku, Tokyo (JP)

(21) Appl. No.: 18/269,459

(22) PCT Filed: Mar. 25, 2021
(86) PCT No.: PCT/JP2021/012609

§ 371 Date: Jun. 23, 2023

(51) Int. Cl. G08G 1/01; B60W 40/09

(52) U.S. Cl. CPC G08G 1/0112; B60W 40/09; B60W 2552/20

(57) ABSTRACT

A driving determination system includes: a memory; and at least one processor coupled to the memory. The processor performs operations. The operations include: sensing dangerous driving of a vehicle based on sensor information of the vehicle; based on image information obtained by photographing inside or outside of the vehicle, detecting a traveling condition regarding traveling of the vehicle at the time the dangerous driving is sensed; and determining whether the sensed dangerous driving is unavoidable driving according to the detected traveling condition.

### TECHNICAL FIELD

The present disclosure relates to a driving determination system that determines driving of a vehicle, and the like.

### BACKGROUND ART

There is a driving evaluation system that determines sudden acceleration/deceleration or the like of a vehicle from an acceleration sensor of a drive recorder and evaluates driving of a driver from the number of times or the like of the sudden acceleration/deceleration or the like. PTL 1 discloses a system that estimates a road condition from a driving operation condition of a vehicle and determines dangerous driving. PTL 2 discloses a system that uses a difference between a norm model and a driver's driving operation as an evaluation value and urges a driver whose evaluation value is equal to or less than a certain evaluation value to act to approach the norm model. PTL 3 discloses a system that compares driving contents with other drivers at the same point and evaluates safe driving. Such a driving evaluation is provided to a manager who manages the driver, and may be adopted as a work evaluation for each driver.

### CITATION LIST

### Patent Literature

PTL 1: JP 2001-074764 A
PTL 2: JP 2020-129289 A
PTL 3: JP 2016-062470 A

### SUMMARY OF INVENTION

### Technical Problem

However, there is a possibility that the determination of sudden deceleration of the vehicle includes, for example, an action in which the driver suddenly decelerates the vehicle in order to avoid a crisis from running out of a pedestrian or an animal. When such driving for avoiding a crisis is evaluated as dangerous driving, the motivation of the driver is lowered.

An object of the present disclosure is to provide a driving determination system and the like capable of estimating a cause of dangerous driving sensed using sensor information of a vehicle.

### Solution to Problem

An aspect of a driving determination system of the present disclosure includes: a sensing unit that senses dangerous driving of a vehicle based on sensor information of the vehicle; a detection unit that, based on image information obtained by photographing inside or outside of the vehicle, detects a traveling condition regarding traveling of the vehicle when the dangerous driving is sensed; and a determination unit that determines whether the sensed dangerous driving is unavoidable driving according to the detected traveling condition.

An aspect of a driving determination method of the present disclosure includes: sensing dangerous driving of a vehicle based on sensor information of the vehicle; detecting, based on image information obtained by photographing inside or outside of the vehicle, a traveling condition regarding traveling of the vehicle when the dangerous driving is sensed; and determining whether the sensed dangerous driving is unavoidable driving according to the detected traveling condition.

An aspect of a program stored in a storage medium of the present disclosure causes a computer to execute: sensing dangerous driving of a vehicle based on sensor information of the vehicle; detecting, based on image information obtained by photographing inside or outside of the vehicle, a traveling condition regarding traveling of the vehicle when the dangerous driving is sensed; and determining whether the sensed dangerous driving is unavoidable driving according to the detected traveling condition.

### Advantageous Effects of Invention

An example advantage according to the present disclosure is that the cause of dangerous driving sensed using sensor information of a vehicle can be estimated.

### BRIEF DESCRIPTION OF DRAWINGS

FIG. 1 is a diagram illustrating an outline of a driving determination system according to a first example embodiment.

FIG. 2 is a diagram illustrating an example of a configuration of the driving determination system according to the first example embodiment.

FIG. 3 is a diagram illustrating an example of a traveling condition based on image information.

FIG. 4 is a diagram illustrating an example of a traveling condition based on sound image information.

FIG. 5 is a diagram illustrating an example of causes of dangerous driving estimated in a traveling condition based on image information and determination.

FIG. 6 is a diagram illustrating an example of causes of dangerous driving estimated in a traveling condition based on sound information and determination.

FIG. 7 is a diagram illustrating an example of a traveling condition based on image information or acoustic information and determination of good driving.

FIG. 8 is a diagram illustrating an example of driving information.

FIG. 9 is a diagram illustrating an example of evaluation information indicating evaluation of driving of a driver.

FIG. 10 is a diagram illustrating a display example in a case where unnecessary dangerous driving is superimposed and displayed on map information.

FIG. 11 is a diagram illustrating display information for identifying unnecessary dangerous driving and unavoidable driving.

FIG. 12 is a diagram illustrating an example in which unnecessary dangerous driving and unavoidable driving are superimposed and displayed on map information.

FIG. 13 is a flowchart illustrating an example of an operation of the driving determination system according to the first example embodiment.

FIG. 14 is a block diagram illustrating an example of a configuration of a driving determination system according to a second example embodiment.

FIG. 15 is a flowchart illustrating an example of an operation of the driving determination system according to the second example embodiment.

FIG. 16 is a block diagram illustrating a hardware configuration of a computer.

### EXAMPLE EMBODIMENT

### First Example Embodiment

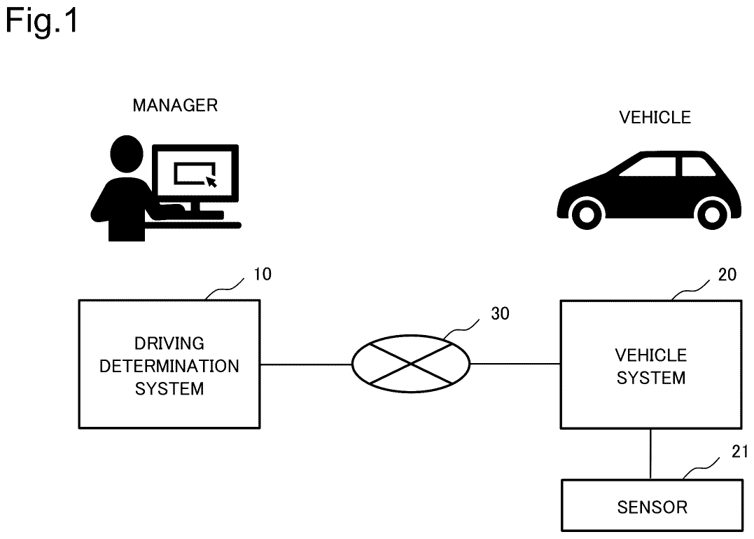

A driving determination system according to a first example embodiment will be described with reference to the drawings. FIG. 1 is a diagram illustrating an outline of the driving determination system according to the first example embodiment. A driving determination system 10 illustrated in FIG. 1 is communicably connected to a vehicle system 20 via a network 30.

(Vehicle System)

The vehicle system 20 illustrated in FIG. 1 is provided in a vehicle such as an automobile, collects sensor information from a sensor 21 installed in the vehicle, and transmits the sensor information to the driving determination system 10. The vehicle system 20 transmits the sensor information in association with a vehicle identifier for identifying the vehicle. The vehicle system 20 is, for example, a computer that executes a function using software. The vehicle system 20 may store the collected sensor information in a recording medium, and the driving determination system 10 may read the sensor information from the recording medium or equipment on which the recording medium is mounted. The vehicle may include a motorcycle (including three wheels), a bicycle, and the like in addition to an automobile (four-wheeled automobile).

The sensor information is, for example, information indicating a state or a behavior of the vehicle and information indicating a driving operation by a driver of the vehicle. The sensor information includes image information obtained by photographing the inside and outside of the vehicle or sound information obtained by collecting a sound inside and outside the vehicle. The sensor information may include information regarding an external environment in which the vehicle travels. The sensor information of the external environment is, for example, temperature, humidity, illuminance, and the like at the time of traveling of the vehicle. Details of the external environment will be described below. The image information and the sound information include a traveling condition outside the vehicle. The traveling condition will be described below. Further, the image information includes a driver and a passenger in the vehicle. The sound information includes a sound in the vehicle or a voice of a driver or a passenger. The sensor information described above is an example, and is not limited thereto.

The sensor 21 may be, for example, a speed sensor that measures a traveling position of the vehicle and the speed of the vehicle, an acceleration sensor that measures the acceleration of the vehicle, or a steering sensor that measures a steering wheel operation of the vehicle. Alternatively, the sensor 21 may be an imaging sensor that images the inside and outside of the vehicle, an acoustic sensor or microphone that collects sounds inside and outside the vehicle. The sensor 21 described above is an example, and is not limited thereto.

(Driving Determination System)

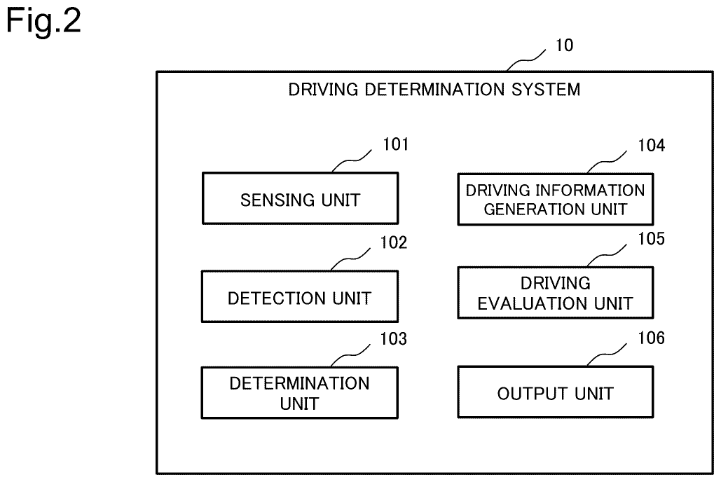

FIG. 2 is a diagram illustrating an example of a configuration of the driving determination system according to the first example embodiment. The driving determination system 10 illustrated in FIG. 2 includes a sensing unit 101, a detection unit 102, a determination unit 103, a driving information generation unit 104, a driving evaluation unit 105, an output unit 106, and a communication unit (not illustrated).

The sensing unit 101 senses dangerous driving of the vehicle based on the sensor information of the vehicle. Dangerous driving means, for example, driving that may endanger traffic. Examples of the element of dangerous driving include sudden deceleration, sudden acceleration, sudden steering, sudden braking, sudden start, traveling on a step, or erratic driving. The element of dangerous driving is an example, and is not limited thereto.

The sensing unit 101 senses dangerous driving due to sudden deceleration, sudden acceleration, sudden start, or sudden braking of the vehicle from the magnitude of acceleration in a front-rear direction of the vehicle. Alternatively, dangerous driving due to sudden steering or erratic driving of the vehicle is sensed from the magnitude of acceleration in a left-right direction of the vehicle. Sensing of dangerous driving is not limited to acceleration, and dangerous driving may be sensed based on sensor information from an accelerator pedal sensor and a steering sensor. The sensing of dangerous driving is an example, and is not limited thereto.

In addition to sensing dangerous driving of the vehicle, the sensing unit 101 may sense gentle driving of the vehicle based on the sensor information of the vehicle. As the gentle driving, for example, gentle acceleration, deceleration, start, stop, handling, or the like may be sensed.

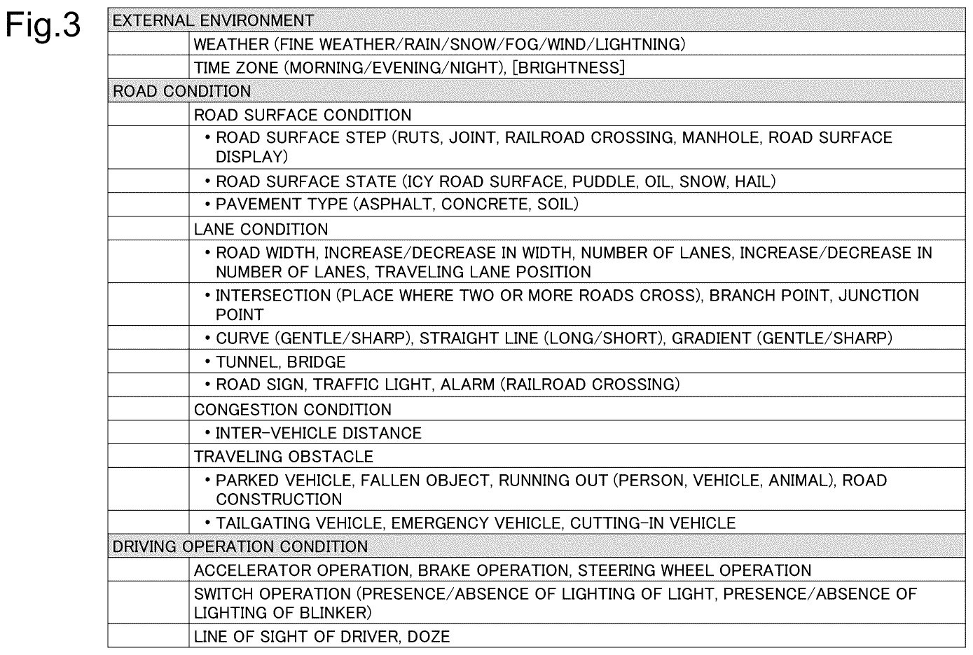

The detection unit 102 detects a traveling condition regarding travel of the vehicle when dangerous driving is sensed based on image information obtained by photographing the inside or outside of the vehicle. FIG. 3 is a diagram illustrating an example of a traveling condition based on image information. The traveling condition based on the image information illustrated in FIG. 3 includes information regarding the external environment, information regarding the road condition, or information regarding the driving operation condition.

The external environment based on the image information is, for example, weather such as fine weather, rain, snow, fog, wind, or lightning. For example, the detection unit 102 detects the presence or absence of rainfall and snowfall during traveling of the vehicle, the degree of visibility, and the like from the photographing data of the outside of the vehicle by using machine learning as a method for detecting the external environment. Alternatively, without using machine learning, the detection unit 102 may detect rainfall, snowfall, or the like by using image processing with reference to a difference in brightness, color, or the like of the photographing data. The external environment or the method for detecting the external environment is an example, and is not limited thereto.

The road condition based on the image information includes a road surface condition, a lane condition, a congestion condition, or a traveling obstacle. The road surface condition includes a road surface step, a road surface state, or a pavement type. The lane condition includes a road width, an increase/decrease in width, the number of lanes, an increase/decrease in the number of lanes, a traveling lane position, an intersection, a branch point, a junction point, and the like. The congestion condition includes an inter-vehicle distance. The traveling obstacle includes a parked vehicle, a fallen object, running out of a person, an animal, or the like, a tailgating vehicle, an emergency vehicle, and the like. The road condition is an example, and is not limited thereto.

The driving operation condition based on the image information includes an accelerator operation, a brake operation, a steering wheel operation, a switch operation, a line of sight of the driver, a doze, a posture during driving, and the like. The detection unit 102 detects, for example, the operation angle of the steering wheel, the presence or absence of the switch operation, the doze of the driver, and the like from the camera image by video analysis. The driving operation condition is an example, and is not limited thereto.

For example, the detection unit 102 detects whether there is a fallen object on the lane on which the vehicle travels based on the image information as the traveling condition (road condition) of the vehicle when dangerous driving is sensed due to sudden deceleration of the vehicle. Alternatively, when the vehicle suddenly accelerates, the detection unit 102 may detect the display or blinking of a traffic light in the traveling direction of the vehicle from the image information as the external environment of the traveling condition.

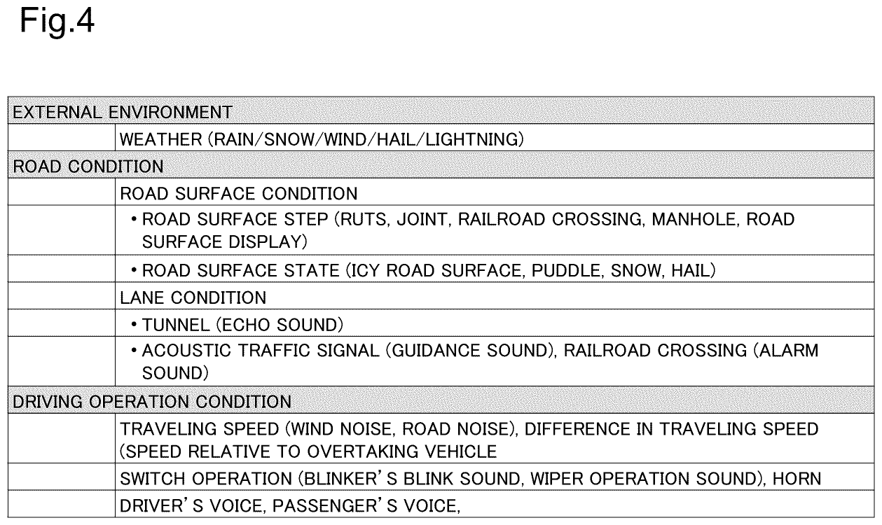

The detection unit 102 may detect a traveling condition regarding travel of the vehicle when dangerous driving is sensed based on sound information obtained by photographing the inside or outside of the vehicle. FIG. 4 is a diagram illustrating an example of a traveling condition based on sound image information. The traveling condition based on the sound information illustrated in FIG. 4 includes, for example, information regarding the external environment, information regarding the road condition, or information regarding the driving operation condition. The external environment based on the sound information is, for example, weather such as rain, snow, wind, hail or lightning. For example, the detection unit 102 detects the presence or absence of rain, snow, wind, hail, or lightning during traveling of the vehicle from acoustic data of the outside of the vehicle by using machine learning as a method for detecting the external environment. The precipitation amount and the magnitude of wind speed may be detected based on the rain sound and the wind sound. Alternatively, a method other than machine learning may be used, and the detection unit 102 may detect rainfall, snowfall, or the like with reference to a difference in frequency, sound pressure, or the like of the acoustic data. The external environment or the method for detecting the external environment is an example, and is not limited thereto.

The road condition based on the sound information includes a road surface condition and a lane condition. The road surface condition includes a road surface step and a road surface state. The lane condition includes a tunnel (echo sound), an acoustic traffic signal (guidance sound), and a railroad crossing (alarm sound). The road condition is an example, and is not limited thereto.

The driving operation condition based on the sound information includes the driver's voice, the passenger's voice, a traveling speed (wind noise, road noise), a switch operation (blinker's blink sound, wiper operation sound), a horn, and the like. The driving operation condition is an example, and is not limited thereto.

For example, the detection unit 102 detects that a melody of an acoustic traffic signal for guiding a pedestrian is played as a traveling condition (external environment) of the vehicle when dangerous driving is sensed due to sudden deceleration of the vehicle.

The determination unit 103 determines whether the sensed dangerous driving is unavoidable driving according to the detected traveling condition. Specifically, the determination unit 103 estimates whether the cause of the dangerous driving is the driver of the vehicle or other than the driver of the vehicle in the detected traveling condition (external environment, road condition, driving operation condition).

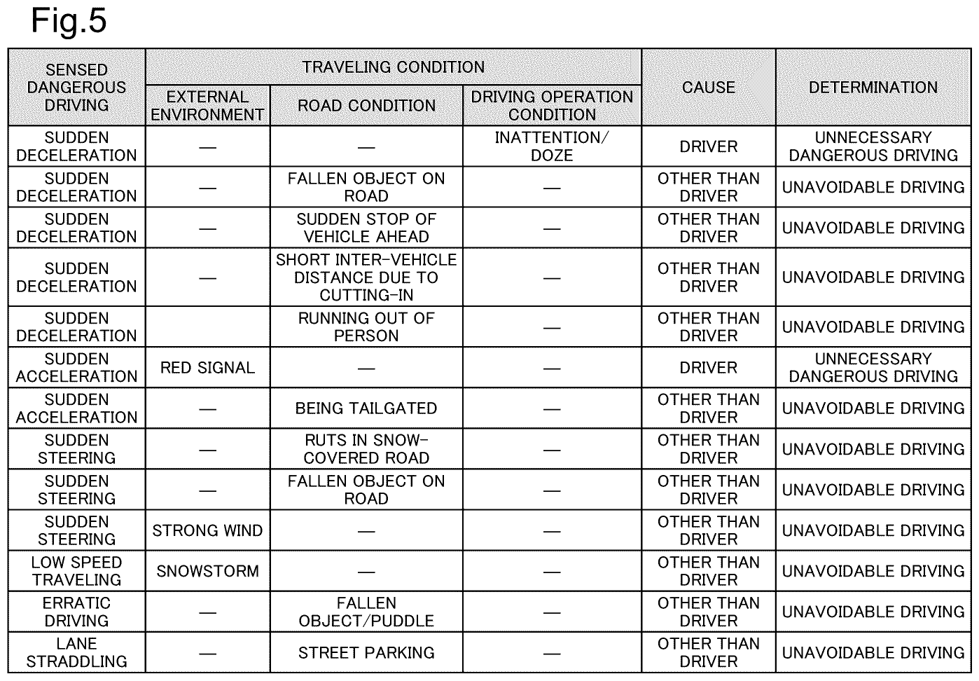

FIG. 5 is a diagram illustrating an example of causes of dangerous driving estimated in a traveling condition based on image information and determination. For example, when the sensed dangerous driving is sudden deceleration and the information of the traveling condition (driving operation condition) includes a doze of the driver, the determination unit 103 estimates that the cause of the dangerous driving is the driver. Alternatively, in another case, when the sensed dangerous driving is sudden deceleration and the information of the traveling condition (road condition) includes a fallen object on the road, the determination unit 103 estimates that the cause of the dangerous driving is other than the driver (in this case, the fallen object).

The determination unit 103 determines that the sensed dangerous driving is unavoidable driving when the cause of the sensed dangerous driving is other than the driver, and determines that the sensed dangerous driving is unnecessary dangerous driving when the cause of the sensed dangerous driving is the driver of the vehicle.

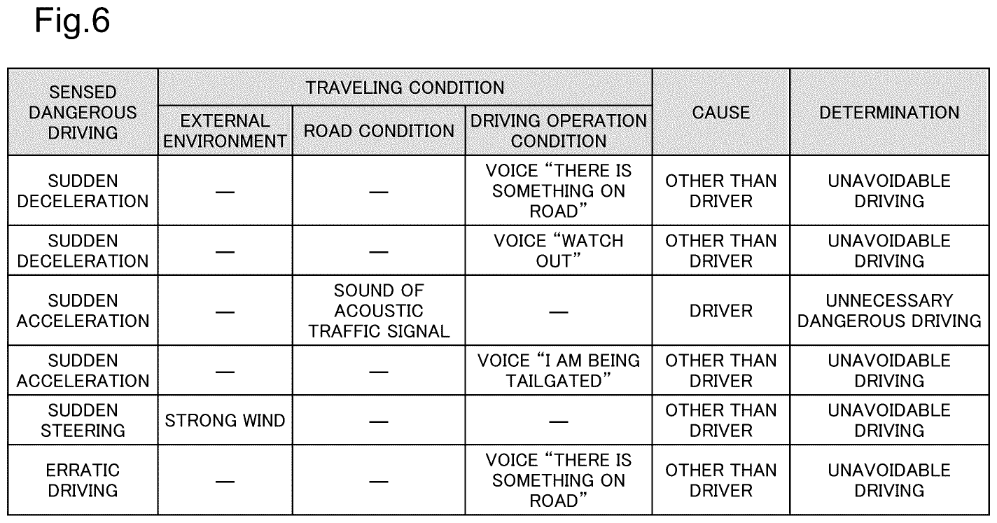

FIG. 6 is a diagram illustrating an example of causes of dangerous driving estimated in a traveling condition based on sound information and determination. For example, when the sensed dangerous driving is sudden deceleration and the information of the traveling condition (road condition) includes a sound of the acoustic traffic signal of a crosswalk, the determination unit 103 estimates that the cause of the dangerous driving is the driver. Alternatively, in another case, when the sensed dangerous driving is sudden steering and the information of the traveling condition (external environment) includes a sound of a strong wind outside the vehicle, the determination unit 103 estimates that the cause of the dangerous driving is other than the driver (the vehicle is pushed by the wind).

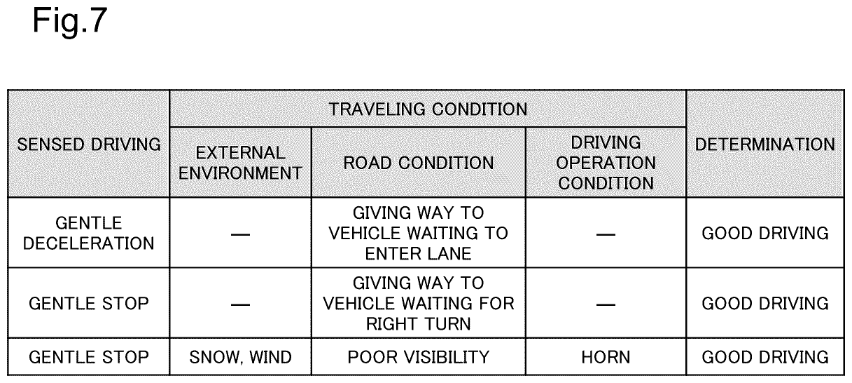

Alternatively, the determination unit 103 may determine whether the sensed driving is good driving according to the traveling condition detected based on the image information or the acoustic information with respect to the sensed driving. Good driving is, for example, gentle driving, careful driving, driving in compliance with a legal speed, driving in consideration of surrounding drivers, driving in consideration of the environment, or the like. FIG. 7 is a diagram illustrating an example of a traveling condition based on image information or acoustic information and determination of good driving. For example, in a case where the sensed driving is gentle deceleration and the information of the traveling condition (road condition) includes a video showing giving way to a vehicle waiting for a right turn, the determination unit 103 determines that the sensed driving is good driving. The definition of good driving and the determination of good driving are examples, and are not limited thereto.

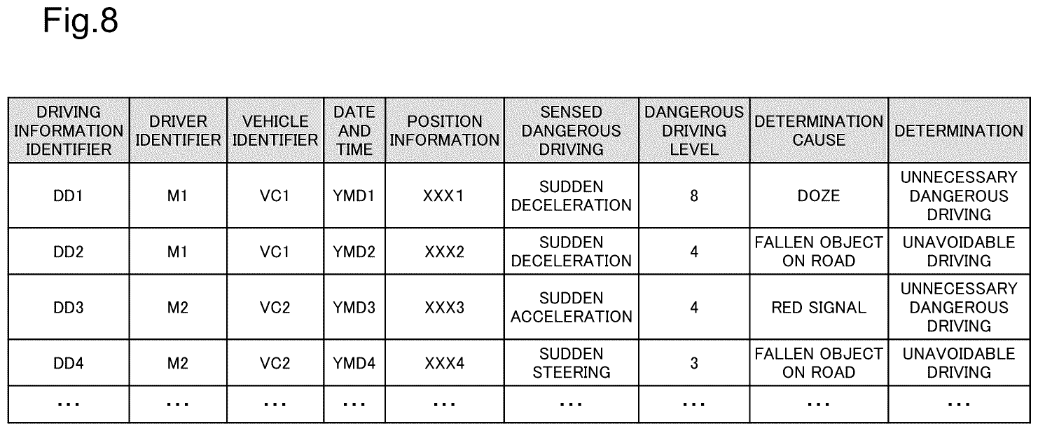

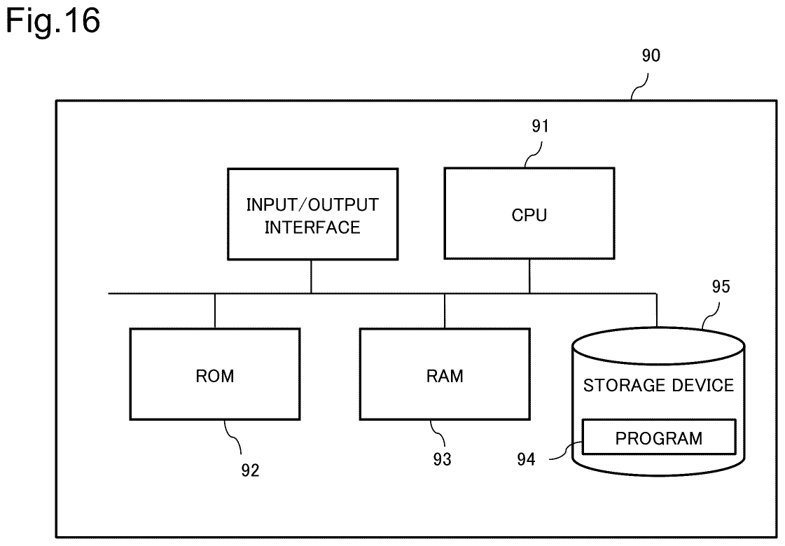

The driving information generation unit 104 generates driving information. The driving information includes information regarding the sensed dangerous driving. FIG. 8 is a diagram illustrating an example of the driving information generated by the driving information generation unit 104 and stored in memory (for example, random access memory (RAM) 93 or a storage device 95 in FIG. 16 described below). The driving information illustrated in FIG. 8 includes items of a driving information identifier, a driver identifier, a vehicle identifier, date and time, position information, a type of dangerous driving, a dangerous driving level, a cause, and determination. The driving information identifier is sequentially assigned in time series, for example, when dangerous driving is sensed by the driving information generation unit 104. The association between the driver identifier and the vehicle identifier may be acquired from, for example, vehicle reservation information stored in the vehicle system 20 or another device. The driving information generation unit 104 acquires, from the sensing unit 101 or a storage unit (not illustrated), information (dangerous driving occurrence date and time, position information indicating occurrence position of dangerous driving, and type of dangerous driving) related to the dangerous driving sensed by the sensing unit 101 and related to the vehicle identifier.

The driving information generation unit 104 assigns a dangerous driving level to the type of dangerous driving of the generated driving information. For example, the magnitude of the dangerous driving level may be set according to the magnitude of the acceleration of sudden deceleration. The manner of assigning the dangerous driving level is an example, and is not limited thereto.

Further, the driving information generation unit 104 may update the driving information according to an additional determination result by the determination unit 103. When the determination unit 103 determines that dangerous driving is unavoidable driving, the driving information generation unit 104 registers “unavoidable driving” in the item of the determination of the driving information, and when the determination unit 103 determines that dangerous driving is unnecessary dangerous driving, the driving information generation unit 104 registers “unnecessary dangerous driving”. The driving information generation unit 104 may register the matter that is the cause of the determination in the item of the determination cause of the driving information based on the determination result. The driving information generation unit 104 causes the storage unit (not illustrated) to store the generated driving information. The driving information generation unit 104 may have a manager setting function that accepts a change in the driving information by the manager so that the manager can mutually change the statuses of “unnecessary dangerous driving” and “unavoidable driving” of the driving information.

The driving evaluation unit 105 calculates an evaluation value regarding driving based on dangerous driving. For example, the driving evaluation unit 105 sets the initial value of the evaluation value to 100, and deducts a point from the evaluation value each time the sensing unit 101 detects dangerous driving. The initial value may be other than 100. The value of deduction due to dangerous driving may be a constant value or may be a value corresponding to a dangerous driving level. For example, the level of deduction may be set based on the level of dangerous driving level.

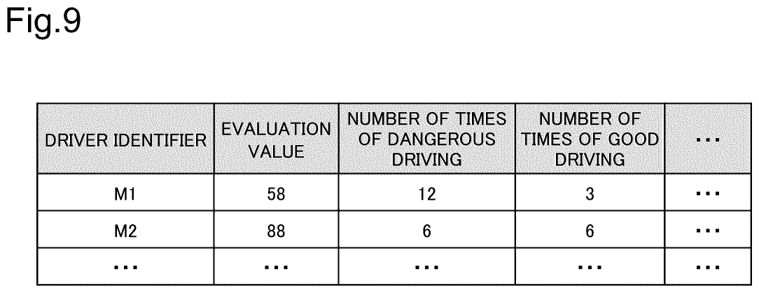

FIG. 9 is a diagram illustrating an example of evaluation information indicating evaluation of driving of a driver. The evaluation information illustrated in FIG. 9 includes items of a driver identifier, an evaluation value, the number of times of dangerous driving, and the number of times of good driving. For example, the evaluation value is calculated by the calculation formula described below.

Evaluation value=100−the number of times of dangerous driving*k1+the number of times of good driving*k2[coefficients k1=4, k2=2]

According to this calculation formula, the evaluation value of M1 illustrated in FIG. 9 is “58”, and the evaluation value of M2 is “88”. The calculation formula and the coefficients thereof are examples, and are not limited thereto.

Further, as another example of the evaluation method, the driving evaluation unit 105 may calculate an evaluation value for each driver by dividing the dangerous driving into elements (sudden acceleration, sudden deceleration, or the like), and calculate a total point based on an average or a sum of the evaluation values of the elements. The driving evaluation unit 105 may add an additional point of good driving or unavoidable driving as another score apart from the deduction due to dangerous driving (two axes). Further, the driving evaluation unit 105 may calculate as one score by combining two scores of the remaining holding score deducted by dangerous driving from the initial value (for example, 100) and the additional score.

The driver identifier may be, for example, an employee number, a membership number, or a personal number. The item of the evaluation information may include a driver name. The number of times of dangerous driving and the number of times of good driving may not be provided. The item of the evaluation information is an example, and is not limited thereto.

The driving evaluation unit 105 may add a point based on good driving in addition to deduction based on dangerous driving. For example, the driving evaluation unit 105 may add a point to the evaluation value according to the number of times that the determination unit 103 determines that good driving is performed as illustrated in FIG. 7. Since driving is evaluated not only by deduction but also by addition, the motivation of the driver is improved, which contributes to safe driving.

The driving evaluation unit 105 causes the storage unit (not illustrated) to store the evaluation information every day and resets the evaluation value to the initial value. The storage of the evaluation information may be other than every day. The resetting of the evaluation value may be performed apart from the storage of the evaluation information.

The output unit 106 generates information to be displayed on a display (not illustrated), and performs display control to display on the display. The output unit 106 performs display control of information regarding unnecessary dangerous driving or unavoidable driving based on the driving information or the evaluation information. For example, the output unit 106 superimposes and displays the type and occurrence position of dangerous driving on the map information based on the driving information.

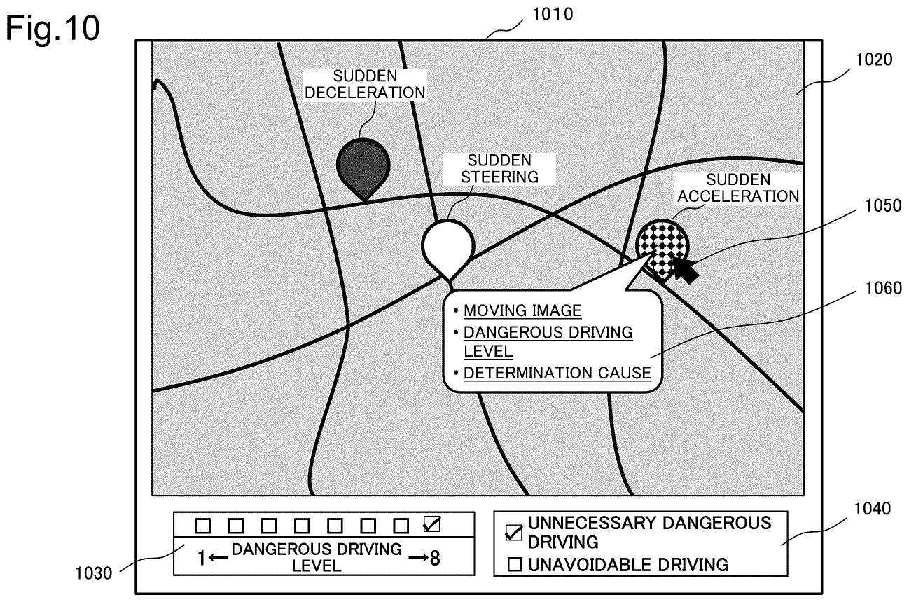

FIG. 10 is a diagram illustrating a display example in a case where unnecessary dangerous driving is superimposed and displayed on map information. The display example of FIG. 10 is a display screen for a manager who manages the driver. Screen display 1010 includes map information 1020, level selection 1030, and display selection 1040. In the map information 1020, a type icon (sudden deceleration icon, sudden steering icon, sudden acceleration icon) of dangerous driving of the vehicle and each occurrence position are superimposed and displayed on the map. For example, the position of the sudden deceleration icon in FIG. 10 is related to the dangerous driving of a driving information identifier D1 of position information XXXI in FIG. 8. A selection link 1060 for displaying a moving image regarding dangerous driving, a dangerous driving level, and a determination cause is displayed by selecting the type icon with a mouse 1050. For example, by clicking “dangerous driving level” in the selection link 1060 with the mouse 1050, the value of the dangerous driving level recorded in the driving information is displayed.

The level selection 1030 is a check box for selecting the dangerous driving level of dangerous driving. When the dangerous driving level of the level selection 1030 is checked, the output unit 106 selects dangerous driving related to the checked dangerous driving level with reference to the driving information illustrated in FIG. 8, and the output unit 106 outputs information of the dangerous driving of the selected dangerous driving level (type icon and content of unnecessary dangerous driving) in a superimposed manner. The dangerous driving levels can be selected in an overlapping manner, and unnecessary dangerous driving of all the dangerous driving levels is output by selecting all. The threshold of the dangerous driving level to be displayed and the number of stages of level can be set optionally.

The display selection 1040 is a check box for selecting and displaying unnecessary dangerous driving and unavoidable driving on the map. Both can be displayed by selecting both. By combining the level selection 1030 and the display selection 1040, for example, when the dangerous driving level is “8”, “unavoidable driving” is output. The display selection is not limited to the dangerous driving level or the like. For example, other items of driving information such as a driver identifier, a vehicle identifier, a date and time, and a region (a range based on the position information) may be used. Further, a search input field for searching for driving information may be provided.

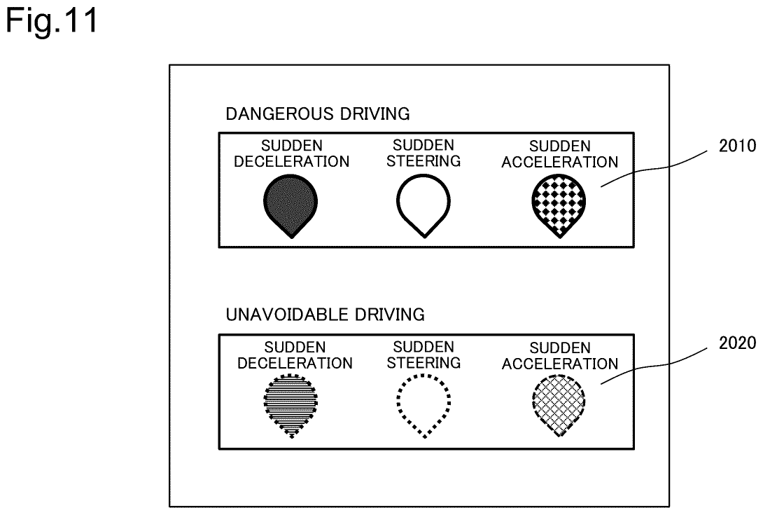

FIG. 11 is a diagram illustrating type icons of unnecessary dangerous driving and unavoidable driving. A dangerous driving icon 2010 illustrated in FIG. 11 indicates sudden deceleration, sudden steering, and sudden acceleration. An unavoidable driving icon 2020 indicates sudden deceleration, sudden steering, and sudden acceleration. For example, in a case where the sensed dangerous driving is unavoidable driving by subsequent determination, the type icon superimposed on the map is changed.

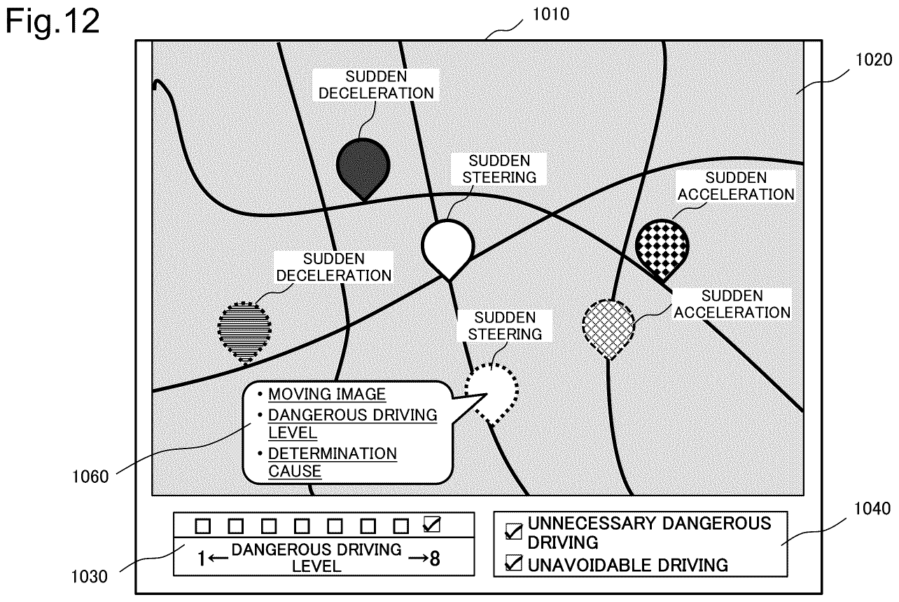

FIG. 12 is a diagram illustrating an example in which unnecessary dangerous driving and unavoidable driving of driving information are superimposed and displayed on map information. When “unavoidable driving” in the display selection 1040 is selected on the display screen illustrated in the display example of FIG. 10, the output unit 106 superimposes and displays the type icons of the unavoidable driving (sudden deceleration, sudden steering, sudden acceleration) on the map of each occurrence position as illustrated in FIG. 12. In the unavoidable driving icon, the selection link for displaying a moving image, a dangerous driving level, and a determination cause is displayed by mouse selection.

(Operation)

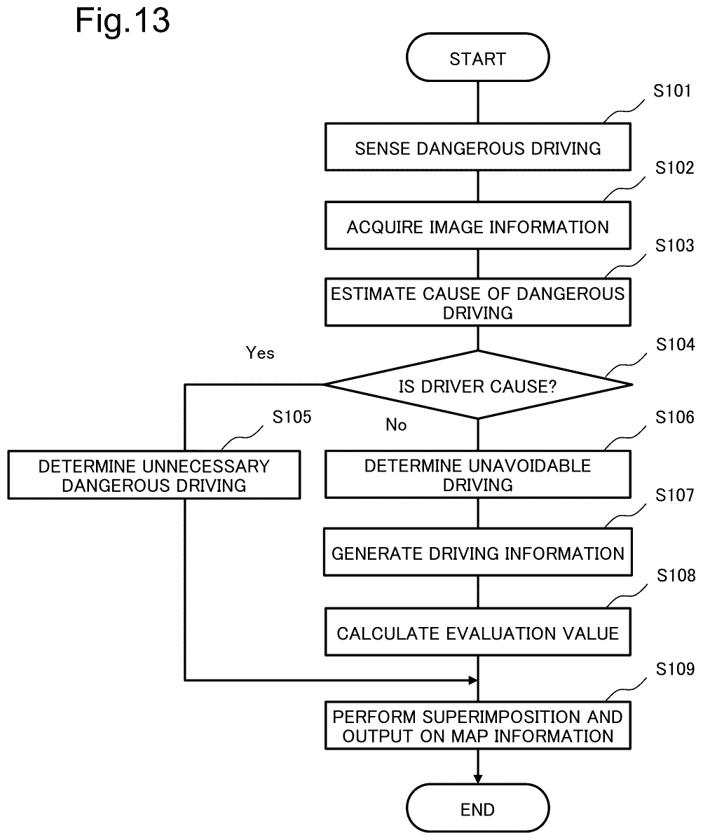

Next, an operation of the driving determination system 10 according to the first example embodiment will be described. FIG. 13 is a flowchart illustrating an example of an operation of the driving determination system according to the first example embodiment.

The driving determination system 10 receives the sensor information of the vehicle transmitted by the vehicle system 20.

The sensing unit 101 senses dangerous driving of the vehicle based on sensor information of the vehicle (step S101). Examples of the element of dangerous driving include sudden deceleration, sudden acceleration, sudden steering, sudden braking, sudden start, traveling on a step, or erratic driving.

The detection unit 102 detects a traveling condition regarding travel of the vehicle when dangerous driving is sensed based on image information obtained by photographing the inside or outside of the vehicle (step S102). The traveling condition based on the image information includes information regarding the external environment, information regarding the road condition, or information regarding the driving operation condition. The detection unit 102 may detect a traveling condition regarding travel of the vehicle when dangerous driving is sensed based on sound information obtained by photographing the inside or outside of the vehicle.

The determination unit 103 determines whether the sensed dangerous driving is unavoidable driving according to the detected traveling condition. The determination unit 103 estimates whether the cause of the dangerous driving is the driver of the vehicle or other than the driver of the vehicle in the detected traveling condition (external environment, road condition, driving operation condition) (step S103). When the cause of the sensed dangerous driving is the driver of the vehicle (Yes in step S104), the determination unit 103 determines that unnecessary dangerous driving is performed (step S105). On the other hand, when the cause of the sensed dangerous driving is other than the driver (No in step S104), the determination unit 103 determines that the dangerous driving is unavoidable driving (step S106).

The determination unit 103 may determine whether the sensed driving is good driving according to the traveling condition detected based on the image information or the acoustic information with respect to the sensed driving. For example, in a case where the sensed driving is gentle deceleration and the information of the traveling condition (road condition) includes a video showing giving way to a vehicle waiting for a right turn, the determination unit 103 determines that the sensed driving is good driving.

The driving information generation unit 104 generates driving information (step S107). The driving information includes, for example, items of a driving information identifier, a driver identifier, a vehicle identifier, date and time, position information, a type of dangerous driving, a dangerous driving level, a cause, and determination. The driving information generation unit 104 acquires, from the sensing unit 101 or a storage unit (not illustrated), information (dangerous driving date and time, position information of the vehicle, and type of dangerous driving) related to the dangerous driving sensed by the sensing unit 101 and related to the vehicle identifier.

The driving information generation unit 104 assigns a dangerous driving level to the type of dangerous driving of the generated driving information.

Further, the driving information generation unit 104 may update the driving information according to an additional determination result by the determination unit 103. When the determination unit 103 determines that dangerous driving is unavoidable driving, the driving information generation unit 104 registers “unavoidable driving” in the item of the determination of the driving information, and when the determination unit 103 determines that dangerous driving is unnecessary dangerous driving, the driving information generation unit 104 registers “unnecessary dangerous driving”. The driving information generation unit 104 may register the matter that is the cause of the determination in the item of the determination cause of the driving information based on the determination result. The manager can mutually change the statuses of “unnecessary dangerous driving” and “unavoidable driving” of the driving information generated using the manager setting function of the driving information generation unit 104.

The driving evaluation unit 105 calculates an evaluation value regarding driving based on dangerous driving (step S108). For example, the driving evaluation unit 105 sets the initial value of the evaluation value to 100, and deducts a point from the evaluation value each time the sensing unit 101 detects dangerous driving. The initial value may be other than 100. The value of deduction due to dangerous driving may be a constant value or may be a value corresponding to a dangerous driving level. For example, the level of deduction may be set based on the level of dangerous driving level.

The driving evaluation unit 105 may add a point based on good driving in addition to deduction based on dangerous driving. For example, the driving evaluation unit 105 may add a point to the evaluation value according to the number of times of driving that the determination unit 103 determines that good driving is performed. Alternatively, the driving evaluation unit 105 may calculate an evaluation value for each driver by dividing the unnecessary dangerous driving into elements (sudden acceleration, sudden deceleration, or the like), and calculate a total point based on an average or a sum of the evaluation values of the elements. The driving evaluation unit 105 may add an additional point of good driving as another score apart from the deduction due to unnecessary dangerous driving (two axes). Further, the driving evaluation unit 105 may calculate as one score by combining two scores of the remaining holding score deducted by unnecessary dangerous driving from the initial value (for example, 100) and the additional score.

The output unit 106 displays and outputs information regarding dangerous driving or unavoidable driving based on the driving information or the evaluation information. For example, the output unit 106 superimposes and displays the type and occurrence position of dangerous driving on the map information based on the driving information (step S109). For example, the output unit 106 superimposes and displays the type icon (sudden deceleration, sudden steering, sudden acceleration) of dangerous driving of the vehicle and each occurrence position on the map in the map information 1020.

When the determination unit 103 estimates that the cause of the sensed dangerous driving is other than the driver, the output unit 106 may notify the manager of the possibility that the sensed dangerous driving is different. An example of the notification is to display “this sudden deceleration may not be dangerous driving”.

### Modification of First Example Embodiment

The driving determination system 10 may be mounted on a vehicle. For example, the configuration of the driving determination system 10 may be mounted on a drive recorder of a vehicle, a driving assistance system of a vehicle, the vehicle system 20, or an app of a smartphone used by a driver.

### Effects of First Example Embodiment

According to the first example embodiment, the driving determination system 10 can estimate the cause of dangerous driving sensed using sensor information of the vehicle. This is because the detection unit 102 detects a traveling condition regarding travel of the vehicle when dangerous driving is sensed based on image information obtained by photographing the inside or outside of the vehicle. Then, from the estimated result, the determination unit 103 can determine whether the sensed dangerous driving is unavoidable driving according to the detected traveling condition.

### Second Example Embodiment

A driving determination system according to a second example embodiment will be described with reference to the drawings. The driving determination system according to the second example embodiment is communicably connected to a vehicle system 20 via a network 30 similarly to the driving determination system 10 according to the first example embodiment.

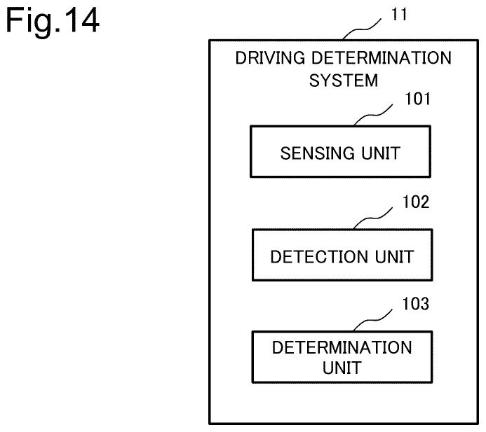

FIG. 14 is a block diagram illustrating an example of a configuration of the driving determination system according to the second example embodiment. A driving determination system 11 illustrated in FIG. 14 includes a sensing unit 101, a detection unit 102, a determination unit 103, and a communication unit (not illustrated). The driving determination system is 11, for example, a computer that executes the functions of the sensing unit 101, the detection unit 102, and the determination unit 103 using software.

The driving determination system 11 according to the second example embodiment has a configuration in which the driving information generation unit 104, the driving evaluation unit 105, and the output unit 106 are omitted from the configuration of the driving determination system 10 according to the first example embodiment. Therefore, detailed description of the configurations of the sensing unit 101, the detection unit 102, and the determination unit 103 is omitted.

The driving determination system 11 receives sensor information of the vehicle transmitted by the vehicle system 20. The sensor information includes image information obtained by photographing the inside and outside of the vehicle or sound information obtained by collecting a sound inside and outside the vehicle.

The sensing unit 101 senses dangerous driving of the vehicle based on the sensor information of the vehicle. Examples of the element of dangerous driving include sudden deceleration, sudden acceleration, sudden steering, sudden braking, sudden start, traveling on a step, or erratic driving. The element of dangerous driving is an example, and is not limited thereto.

The detection unit 102 detects a traveling condition regarding travel of the vehicle when dangerous driving is sensed based on image information obtained by photographing the inside or outside of the vehicle. The traveling condition based on the image information includes information regarding the external environment, information regarding the road condition, or information regarding the driving operation condition. The external environment based on the image information is, for example, weather such as fine weather, rain, snow, fog, wind, or lightning. The road condition based on the image information includes, for example, a road surface condition, a lane condition, a congestion condition, or a traveling obstacle. The driving operation condition based on the image information includes an accelerator operation, a brake operation, a steering wheel operation, a switch operation, a line of sight of the driver, a doze, and the like.

The detection unit 102 may detect a traveling condition regarding travel of the vehicle when dangerous driving is sensed based on sound information obtained by photographing the inside or outside of the vehicle. The traveling condition based on the sound information includes, for example, information regarding the external environment, information regarding the road condition, or information regarding the driving operation condition. The external environment based on the sound information is, for example, weather such as rain, snow, wind, hail or lightning. The road condition based on the sound information includes a road surface condition and a lane condition. The road surface condition includes a road surface step and a road surface state. The lane condition includes a tunnel (echo sound), an acoustic traffic signal (guidance sound), and a railroad crossing (alarm sound). The road condition is an example, and is not limited thereto.

The driving operation condition based on the sound information includes the driver's voice, the passenger's voice, a traveling speed (wind noise, road noise), a switch operation (blinker's blink sound, wiper operation sound), a horn, and the like. The driving operation condition is an example, and is not limited thereto.

The determination unit 103 determines whether the sensed dangerous driving is unavoidable driving according to the detected traveling condition. Specifically, the determination unit 103 estimates whether the cause of the dangerous driving is the driver of the vehicle or other than the driver of the vehicle in the detected traveling condition (external environment, road condition, driving operation condition).

For example, when the sensed dangerous driving is sudden deceleration and the information of the traveling condition (driving operation condition) includes a doze of the driver, the determination unit 103 estimates that the cause of the dangerous driving is the driver.

The determination unit 103 determines that the dangerous driving is unavoidable driving when the cause of the sensed dangerous driving is other than the driver, and determines that the sensed dangerous driving is dangerous driving when the cause of the sensed dangerous driving is the driver of the vehicle.

For example, when the sensed dangerous driving is sudden deceleration and the information of the traveling condition (road condition) includes a sound of the acoustic traffic signal of a crosswalk, the determination unit 103 estimates that the cause of the dangerous driving is the driver.

Alternatively, the determination unit 103 may determine whether the sensed driving is good driving according to the traveling condition detected based on the image information or the acoustic information with respect to the sensed driving. For example, in a case where the sensed driving is gentle deceleration and the information of the traveling condition (road condition) includes a video showing giving way to a vehicle waiting for a right turn, the determination unit 103 determines that the sensed driving is good driving.

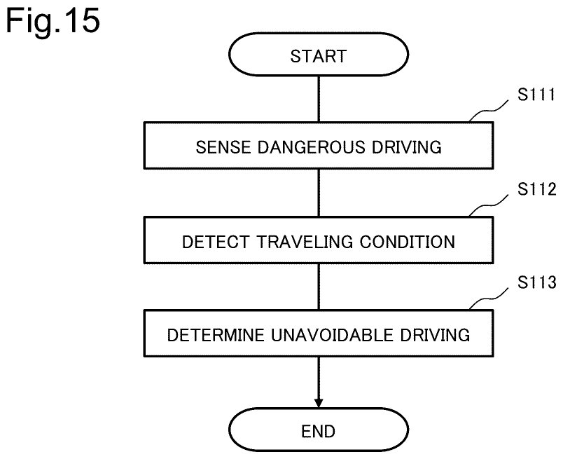

FIG. 15 is a flowchart illustrating an example of an operation of the driving determination system according to the second example embodiment. The driving determination system 11 receives sensor information of the vehicle transmitted by the vehicle system 20. The sensor information includes image information obtained by photographing the inside and outside of the vehicle or sound information obtained by collecting a sound inside and outside the vehicle.

The sensing unit 101 senses dangerous driving of the vehicle based on sensor information of the vehicle (step S111). Examples of the element of dangerous driving include sudden deceleration, sudden acceleration, sudden steering, sudden braking, sudden start, traveling on a step, or erratic driving.

The detection unit 102 detects a traveling condition regarding travel of the vehicle when dangerous driving is sensed based on image information obtained by photographing the inside or outside of the vehicle (step S112). The traveling condition based on the image information includes information regarding the external environment, information regarding the road condition, or information regarding the driving operation condition. The detection unit 102 may detect a traveling condition regarding travel of the vehicle when dangerous driving is sensed based on sound information obtained by photographing the inside or outside of the vehicle.

The determination unit 103 determines whether the sensed dangerous driving is unavoidable driving according to the detected traveling condition (step S113). The determination unit 103 estimates whether the cause of the dangerous driving is the driver of the vehicle or other than the driver of the vehicle in the detected traveling condition (external environment, road condition, driving operation condition). The determination unit 103 determines that the dangerous driving is unavoidable driving when the cause of the sensed dangerous driving is other than the driver, and determines that the sensed dangerous driving is dangerous driving when the cause of the sensed dangerous driving is the driver of the vehicle.

Alternatively, the determination unit 103 may determine whether the sensed driving is good driving according to the traveling condition detected based on the image information or the acoustic information with respect to the sensed driving. For example, in a case where the sensed driving is gentle deceleration and the information of the traveling condition (road condition) includes a video showing giving way to a vehicle waiting for a right turn, the determination unit 103 determines that the sensed driving is good driving.

### Modification of Second Example Embodiment

The driving determination system 11 of the second example embodiment may be mounted in the vehicle system 20 and transmit a determination result. The transmission destination of the determination result may be the driving determination system 10 of the first example embodiment, or may be another driving determination system obtained such that the sensing unit 101, the detection unit 102, and the determination unit 103 are excluded from the driving determination system 10 and the driving information generation unit 104 and the driving evaluation unit 105 are provided.

### Effects of Second Example Embodiment

According to the second example embodiment, the driving determination system 11 can estimate the cause of dangerous driving sensed using sensor information of the vehicle. This is because the detection unit 102 detects a traveling condition regarding travel of the vehicle when dangerous driving is sensed based on image information obtained by photographing the inside or outside of the vehicle. Then, from the estimated result, the determination unit 103 can determine whether the sensed dangerous driving is unavoidable driving according to the detected traveling condition.

(Hardware Configuration)

FIG. 16 is a diagram illustrating an example of a hardware configuration of a computer. The driving determination system 10 is achieved by executing a program (software program, computer program) in a CPU 91 of a computer 90 illustrated in FIG. 16. The functions of the configurations of the driving determination systems 10 and 11 are achieved by executing the program. Some configurations of the driving determination systems 10 and 11 may be configured by an external device (not illustrated), and provided from the external device to the driving determination systems 10 and 11 via a network. The configuration of the driving determination system 10 may be achieved by the central processing unit (CPU) 91 reading a program 94 from read only memory (ROM) 92 or the storage device 95 and executing the read program 94 using the CPU 91 and random access memory (RAM) 93. The present disclosure described using the above-described example embodiments as an example can be regarded as being configured by a code indicating a computer program or a computer-readable storage medium storing the code indicating the computer program. The computer-readable storage medium is, for example, the storage device 95, a removable magnetic disk medium, an optical disk medium, a memory card, or the like, which is not illustrated. The configuration of each example embodiment may be dedicated hardware by an integrated circuit. The driving determination systems 10 and 11 may be achieved by cloud computing.

The present disclosure is not limited to the above-described example embodiments, and various changes can be made, and an example embodiment obtained by appropriately combining configurations, operations, and processes disclosed in different example embodiments is also included in the technical scope of the present disclosure.

The present disclosure is not limited to the above-described example embodiments. That is, the present invention can apply various aspects that can be understood by those skilled in the art within the scope of the present disclosure.

### REFERENCE SIGNS LIST

10, 11 driving determination system
20 vehicle system
21 sensor
101 sensing unit
102 detection unit
103 determination unit
104 driving information generation unit
105 driving evaluation unit
106 output unit

What is claimed is:

1. A driving determination system comprising:
a memory; and
at least one processor coupled to the memory,
the processor performing operations, the operations comprising:
sensing dangerous driving of a vehicle based on sensor information of the vehicle;
based on image information obtained by photographing inside or outside of the vehicle, detecting a traveling condition regarding traveling of the vehicle when at the time the dangerous driving is sensed; and
determining whether the sensed dangerous driving is unavoidable driving according to the detected traveling condition.

2. The driving determination system according to claim 1, wherein
the traveling condition is at least one of an external environment in which the vehicle is traveling, a road condition in which the vehicle is traveling, and a driving operation condition regarding a driving operation of the vehicle.

3. The driving determination system according to claim 1, wherein the operations further comprise:
estimating whether a cause of the sensed dangerous driving is a driver of the vehicle or other than the driver of the vehicle according to the traveling condition.

4. The driving determination system according to claim 3, wherein the operations further comprise:
determining that the dangerous driving is unavoidable driving in a case that the cause of the sensed dangerous driving is other than the driver.

5. The driving determination system according to claim 1, wherein the operations further comprise:
determining that the dangerous driving is unnecessary dangerous driving in a case that the cause of the sensed dangerous driving is a driver of the vehicle.

6. The driving determination system according to claim 1, wherein the operations further comprise:
generating driving information including information regarding the sensed dangerous driving.

7. The driving determination system according to claim 6, wherein
the driving information includes a date and time of the dangerous driving, an occurrence position of the dangerous driving, and a type of the dangerous driving.

8. The driving determination system according to claim 1, wherein the operations further comprise:
calculating an evaluation value regarding driving of the vehicle based on a number of times of dangerous driving or a dangerous driving level.

9. The driving determination system according to claim 8, wherein the operations further comprise:
excluding the dangerous driving determined to be the unavoidable driving from calculation of the evaluation value.

10. The driving determination system according to claim 8, wherein the operations further comprise:
determining whether the sensed driving is good driving based on the traveling condition, and raising the evaluation value according to a number of times of the good driving.

11. The driving determination system according to claim 6, wherein the operations further comprise:
superimposing and displaying a type of the dangerous driving and an occurrence position of the dangerous driving on map information based on the driving information.

12. (canceled)

13. A driving determination method comprising:
sensing dangerous driving of a vehicle based on sensor information of the vehicle;
detecting, based on image information obtained by photographing inside or outside of the vehicle, a traveling condition regarding traveling of the vehicle at the time the dangerous driving is sensed; and
determining whether the sensed dangerous driving is unavoidable driving according to the detected traveling condition.

14. A non-transitory computer-readable storage medium embodying a program for causing a computer to perform a method, the method comprising:
sensing dangerous driving of a vehicle based on sensor information of the vehicle;
detecting, based on image information obtained by photographing inside or outside of the vehicle, a traveling condition regarding traveling of the vehicle at the time the dangerous driving is sensed; and
determining whether the sensed dangerous driving is unavoidable driving according to the detected traveling condition.
